(19) United States
(12) Patent Application Publication
(10) Pub. No.: US 2026/0309740 A1
(43) Pub. Date: Oct. 8, 2026

(54) MULTICHANNEL PIPETTING SYSTEM

(71) Applicant: GILSON, INC., Middleton, WI (US)

(72) Inventors: Bruno DUDEK, ORRY LA VILLE (FR); Stéphane GUICHARDON, LOUVECIENNES (FR); Fabrice MERRY, CHATOU (FR)

(21) Appl. No.: 19/478,816

(22) PCT Filed: Apr. 12, 2024
(86) PCT No.: PCT/EP2024/060084

§ 371 Date: Oct. 26, 2025

(30) Foreign Application Priority Data
May 9, 2023 (FR) FR2304564

(51) Int. Cl. G01N 35/10

(52) U.S. Cl. CPC G01N 35/1065; G01N 35/1011

(57) ABSTRACT

A pipetting system includes a pipetting head and a frame having a base provided with at least one tray configured to accommodate at least one consumable. A tower extending from the base includes at least one linear guide rail extending along a vertical axis. A translating device to translate the pipetting head. A controller includes a measuring device to measure information representative of the separation of the pipetting head from the base, an analyzer to analyze the information representative of the separation of the pipetting head from the base to infer therefrom the position of the pipetting head. The controller activates the motor according to the position of the pipetting head and at least one predefined stop. At least one predefined stop is located between the maximum position and the minimum position of the pipetting head.

### FIELD OF THE INVENTION

The present invention relates to the field of pipetting systems, such as sampling pipettes, also referred to as pipetting systems, laboratory pipetting systems, or laboratory pipettes, or liquid transferring pipettes, intended for the calibrated sampling and introduction of liquid into containers.

The invention preferably applies to motorized or semi-motorized pipetting systems, with a manual or servo-controlled pipetting head movement and motorized pipetting, but may also apply to manual pipetting systems.

The invention applies to air displacement or positive displacement pipetting systems.

### PRIOR ART

For many years, pipetting systems, whether motorized, semi-motorized or even manual, have undergone many improvements in design.

From the prior art, pipetting systems are known comprising a pipetting head, a base comprising one or more trays intended to face the pipetting head, and a tower extending from the base and comprising a linear guide rail.

Conventionally, the pipetting head comprises one or more channels, arranged in a rectangular matrix with one or more rows and one or more columns. Each of these pipetting channels is typically fitted with an end piece intended to cooperate with a pipetting tip, which may be disposable, by press-fitting so that it can receive or dispense liquid.

This pipetting head can, in a known manner, be moved in translation along said linear guide rail between at least a maximum position and a minimum position. This movement of the pipetting head may be performed either manually by a user who can for example grasp the pipetting head by hand so as to apply upward or downward pressure in order to raise or lower the pipetting head respectively, or fully automatically by means of a drive motor, in which case the user usually only has to press a button or activate a lever to move the pipetting head.

A disadvantage of pipetting systems with a manually operated pipetting head is that the accuracy of the positioning of the pipetting head depends on how easily this pipetting head can be moved and stopped at a desired position in order, for example, to fit pipetting tips or perform a pipetting operation. In addition, this accuracy may be reduced by the inertia of the pipetting head due to its weight as well as the accuracy of users themselves. It should also be noted that inertia can cause the pipetting head to slow down during its movement.

Motorized pipetting systems have the disadvantage of being relatively expensive, particularly in terms of energy and maintenance, because the motor is in continuous use, which results in high power consumption and premature wear of the motor and the various components that move the pipetting head. Furthermore, an automated system typically only allows the user to position the pipetting head in positions predefined in the pipetting system's on-board computer, leaving little possibility for movement. In addition, such motorized pipetting systems can be relatively noisy during periods of long, repeated use.

There is therefore a need to improve the existing system, and in particular to provide a reliable pipetting system that offers users more freedom of movement of the pipetting head and allows precise positioning of the pipetting head in a desired position while limiting any risk of damage to the head, while reducing the energy consumption of such a pipetting system.

### DISCLOSURE OF THE INVENTION

The invention aims to at least partly address the aforementioned disadvantages of the prior art.

To this end, the invention relates to a pipetting system comprising:
a frame comprising a base provided with at least one tray configured to accommodate at least one consumable, and a tower extending from said base and comprising at least one linear guide rail extending along a vertical axis V;
a pipetting head housing at least one pipetting channel intended to be provided with an end piece configured to cooperate with a pipetting tip so as to receive or dispense liquid, said pipetting head being movable in translation along said linear guide rail in at least one predefined range of movement between at least one maximum position forming a maximum distance from said base and a minimum position forming a minimum distance from said base;
means for driving said pipetting head in translation comprising:
   a motor for driving in translation said pipetting head, comprising a motor shaft mounted to rotate along a motor axis R that is fixed relative to said frame and is substantially orthogonal to said vertical axis V;
   a toothed pinion mounted to rotate about said motor axis;
   a motion transmission roller arranged between said motor and said toothed pinion so as to transmit a rotational movement between said motor and said toothed pinion;
   a rack mounted to as to be movable in translation along said vertical axis V, said rack being integral with said pipetting head so as to drive it in translation, and being arranged in contact with said toothed pinion so that a rotation of said toothed pinion causes a translation of said rack along said vertical axis V and a translation of said rack along said vertical axis causes a rotation of said toothed pinion,
control means comprising:
   means for measuring information representative of said distance between said pipetting head and said base;
   means for analyzing said information representative of said distance between said pipetting head and said base, so as to deduce therefrom said position of said pipetting head;
   control means configured to activate said motor according to said position of said pipetting head and at least one predefined stop, said at least one predefined stop being located between said maximum position and said minimum position of the pipetting head.

Thus, the invention proposes a novel and inventive approach, which makes it possible to at least partly resolve some of the disadvantages of the prior art.

In particular, by implementing control means that activate and therefore power the motor only when necessary and with the necessary power, it is ensured that the pipetting system is economical in terms of energy consumption. Furthermore, this also limits wear and tear on components, in particular drive and control means.

In addition, this makes it possible to provide a pipetting system that gives users a great deal of freedom of control so that they can pre-set stops and maneuver the pipetting head within a predefined range of motion.

Lastly, such a pipetting system uses control means that are relatively simple in mechanical terms and relatively inexpensive.

According to one aspect of at least one embodiment of the invention, when said pipetting head reaches the level of said at least one predefined stop, the control means activate said motor so as to block the translational movement of said pipetting head along said linear guide rail.

This also allows the motor to only be switched on at a predefined blocking power when and with the power required, making the pipetting system energy-efficient.

According to one aspect of at least one embodiment of the invention, the measuring means comprise a magnetic encoder provided with at least one magnet and a magnetometer, said at least one magnet being fixed to said toothed pinion and being arranged facing said magnetometer fixed to said frame of the pipetting system and configured to measure a value of a magnetic field of said at least one magnet so that a rotation of said toothed pinion about said motor axis R results in a variation of said value of said magnetic field of said at least one magnet measured by said magnetometer. Furthermore, said information representative of the distance of said pipetting head is measured by said magnetic encoder, and comprises the number of revolutions made by said toothed pinion as well as said value of the magnetic field of said at least one magnet, said analysis means deducing said position of said pipetting head from said measured value of said magnetic field of said at least one magnet and the number of revolutions performed by said toothed pinion.

Thus, the measuring means have a magnetic angle encoder type function, with a revolution counter, so as to provide measurements of the value of said magnetic field of said magnet that are relatively accurate and quick to obtain.

According to one aspect of at least one embodiment of the invention, said motion transmission roller has a protrusion extending along said motor axis R and around which said toothed pinion is rotatably mounted. Furthermore, said toothed pinion comprises two elongated holes symmetrical to said motor axis R, said motion transmission roller having two protruding pins facing said toothed pinion so that each of said two pins is mounted slidably in one of said two elongated holes by movement of said motion transmission roller relative to said toothed pinion, said two pins and said motor axis R being aligned in a plane orthogonal to said vertical axis V.

According to one aspect of at least one embodiment of the invention, said at least one magnet is provided in a housing formed in said protrusion and is mounted so as to be movable in helical rotation about said motor axis R, said number of revolutions performed by said toothed pinion depending on the distance between said magnet and said magnetometer.

According to one aspect of at least one embodiment of the invention, said at least one magnet is arranged on a support linked to said toothed pinion and mounted so as to rotate about an axis M that is fixed relative to the toothed pinion and parallel to said motor axis R.

According to one aspect of at least one embodiment of the invention, one of said two pins forms said axis M of rotation of said support, said axis M being parallel and offset with respect to said motor axis R, said value of said magnetic field of said at least one magnet measured by said magnetometer depending on a position of each of said two pins in said two elongated holes.

According to one aspect of at least one embodiment of the invention, said measuring means are configured to detect a movement of said pipetting head by the sliding of each of said two pins in said two elongated holes from a default position in which each of said two pins is centered relative to the elongated hole in which they are slidably mounted, and an offset position in which each of said two pins is offset relative to the center of the elongated hole in which they are slidably mounted. Furthermore, said control means are configured to control the speed and direction of rotation of said motor so as to return each of said two pins to said default position.

According to one aspect of at least one embodiment of the invention, when said pipetting head reaches the level of said at least one predefined stop, each of said two pins abuts against an edge of said elongated hole in which it is slidably mounted.

According to a particular aspect of at least one embodiment of the invention, the measuring means comprise an angle encoder provided with two magnets and two angle sensors, a first of said two magnets being fixed to said toothed pinion and being arranged facing a first of said two angle sensors fixed to said frame of the pipetting system and configured to measure an angle variation at said toothed pinion, a second of said two magnets being fixed to said motor and being arranged facing a second of said two angle sensors fixed to said frame of the pipetting system and configured to measure an angle variation at said motor, so that a rotation of said toothed pinion about said motor axis causes a variation in said angle value of said first of said two magnets measured by said first of said two angle sensors, and causes a phase shift between said angle value of said first of said two magnets measured by said first of said two angle sensors and said angle value of said second of said two magnets measured by said second of said two angle sensors.

Furthermore, said information representative of a distance between said pipetting head is measured by said angle encoder, and comprises a number of revolutions performed by said toothed pinion as well as a phase shift value between said angle value of said first of said two magnets measured by said first of said two angle sensors and said angle value of said second of said two magnets measured by said second of said two angle sensors, said analysis means deducing said position of said pipetting head from said phase shift value and the number of revolutions performed by said toothed pinion.

According to a particular aspect of at least one embodiment of the invention, said number of revolutions performed by said toothed pinion is deduced from the rotation of said second of said two magnets.

According to a particular aspect of at least one embodiment of the invention, said motion transmission roller has a protrusion extending along said motor axis and around which said toothed pinion is rotatably mounted. Furthermore, said toothed pinion comprises two elongated holes that are symmetrical to said motor axis, said motion transmission roller having two protruding pins facing said toothed pinion so that each of said two pins is mounted slidably in one of said two elongated holes by movement of said motion transmission roller relative to said toothed pinion, the two pins and the motor axis being aligned in a plane orthogonal to said vertical axis.

According to a particular aspect of at least one embodiment of the invention, when said pipetting head reaches the level of said at least one predefined stop, each of said two pins abuts against an edge of said elongated hole in which it is slidably mounted.

According to a particular aspect of at least one embodiment of the invention, each of said two pins is connected on either side of one of said two elongated holes by means of two return springs in such a position as to return each of said two pins to said default position. According to one aspect of at least one embodiment of the invention, the means for driving said pipetting head comprise at least one constant force spring connected to said rack and configured to hold said pipetting head in a given position.

This makes it possible to provide stability to the pipetting head by ensuring that it is held in a given position, which can correspond to a position desired by a user.

According to one aspect of at least one embodiment of the invention, it further comprises monitoring means, provided on said pipetting head and/or on said tower and intended to be positioned opposite said tray.

According to one aspect of at least one embodiment of the invention, the control means comprise monitoring means capable of delivering information belonging to the group comprising:
information on the presence of a support on said tray;
number of pipetting tips not yet used
information relating to a protocol step to be performed, in progress, or completed;
information on the date or time when a pipetting protocol was performed;
a scheduled maintenance date;
information identifying consumables present on the tray;
identification information on the pipetting system;
information on the arrival of the pipetting head in the stop position;
information on the vertical position of the pipetting head and/or the distance between the pipetting head and the base.

According to one aspect of at least one embodiment of the invention, said control means comprise data storage means and/or network antenna capable of communicating with a remote terminal.

The invention also relates to a method for controlling a pipetting system according to one of the aforementioned embodiments, implemented by said control means, the method being characterized in that it comprises the following steps:
a step of measuring, using said measuring means, information representative of said distance between said pipetting head and said base;
a step of analyzing, using said analysis means, said information representative of said distance between said pipetting head and said base, so as to deduce therefrom said position of said pipetting head;
a step of controlling said motor, by said control means, according to said position of said pipetting head and at least one predefined stop, said at least one predefined stop being located between said maximum position and said minimum position of the pipetting head.

According to one aspect of at least one embodiment of the invention, the method comprises a preliminary step of setting said at least one predefined stop.

According to one aspect of at least one embodiment of the invention, the method comprises a preliminary step of calibrating the measuring means.

According to one aspect of at least one embodiment of the invention, the method comprises a step of positioning said pipetting head from a storage position to said predefined range of movement or from said predefined range of movement to a storage position.

According to one aspect of at least one embodiment of the invention, the method comprises a step of detecting the movement of the pipetting head by detecting, with said measuring means, the sliding of each of said two pins in said two elongated holes from a default position in which each of said two pins is centered relative to the elongated hole in which they are slidably mounted, and an offset position in which each of said two pins is offset relative to the center of the elongated hole in which they are slidably mounted.

In this case, according to one aspect of at least one embodiment of the invention, the method comprises a step of controlling the rotational speed of said motor, by said control means, so as to return each of said two pins to said default position.

According to one aspect of at least one embodiment of the invention, the method comprises a step of detecting reaching at least one predefined stop, the control means activating said motor so as to block the translational movement of said pipetting head along said linear guide rail.

### BRIEF DESCRIPTION OF THE FIGURES

The invention, as well as its various advantages, will be more easily understood in light of the following description of an illustrative and non-limiting embodiment thereof, and the accompanying drawings in which:

FIG. 1 is a side perspective view of a pipetting system according to a first embodiment of the invention;

FIG. 2 is a perspective view of a portion of the pipetting system of FIG. 1;

FIG. 3 is another perspective view of a portion of the pipetting system of FIG. 1, with the pipetting head in the maximum position;

FIG. 4 is another perspective view of a portion of the pipetting system of FIG. 1, with the pipetting head in the minimum position;

FIG. 5 is another perspective view of a portion of the pipetting system of FIG. 1;

FIG. 6 is a detailed perspective view of a portion of FIG. 5;

FIG. 7 is a diagram representing the means for controlling the pipetting system according to the first embodiment of the invention

FIG. 8 is another front perspective view of a portion of the pipetting system of FIG. 1;

FIG. 9 is a cross-sectional view of FIG. 8;

FIG. 10 is another side perspective view of a portion of the pipetting system of FIG. 1, the pins being in an offset position;

FIG. 11 is another side perspective view of a portion of the pipetting system of FIG. 1, the pins being in a different offset position from FIG. 10;

FIG. 12 is another side perspective view of a portion of the pipetting system of FIG. 1, the pins being in a default position;

FIG. 13 is a perspective cross-sectional view of a portion of a pipetting system according to a second embodiment of the invention;

FIG. 14 is a side view of a portion of a pipetting system according to the second embodiment of the invention;

FIG. 15 is a side view of a portion of a pipetting system according to a third embodiment of the invention;

FIG. 16 is another side view of a portion of a pipetting system according to the third embodiment of the invention;

FIG. 17 is another side view of a portion of a pipetting system according to the third embodiment of the invention;

FIG. 18 is a perspective view of a pipetting system according to any one of the three embodiments;

FIG. 19 is a side perspective view of a portion of a pipetting system according to the fourth embodiment of the invention;

FIG. 20 is another side perspective view of a portion of a pipetting system according to the fourth embodiment of the invention;

FIG. 21 is a cross-sectional side perspective view of a portion of a pipetting system according to the fourth embodiment of the invention;

FIG. 22 is a side view of a portion of a pipetting system according to the fourth embodiment of the invention, and

FIG. 23 is a side view of a portion of a pipetting system according to the fourth embodiment of the invention.

### DETAILED DESCRIPTION OF AN EMBODIMENT OF THE INVENTION

The general principle of the invention is based on the implementation of control means for collecting information representative of the distance between the pipetting head and the base, analyzing it so as to deduce therefrom the position of the pipetting head, and activating the motor according to the position of the pipetting head and at least one predefined stop.

The distance between the pipetting head and the base is understood to be the distance separating the pipetting head and the base.

In other words, the distance between the pipetting head and the base denotes a distance between the lower wall of the pipetting head, which is the wall directly opposite the base, and the upper wall of the base, which is the wall directly opposite the pipetting head.

In other words, the distance between the pipetting head and the base is the shortest distance separating the pipetting head and the base.

The ability to set stops, and thus have predefined stops, makes it easier to position the pipetting head in one or more specific positions above the tray and any consumables that may be positioned there, thus avoiding any risk of damage to the pipetting head, end pieces or even consumables.

The invention can be applied to both air-displacement and positive-displacement pipetting systems.

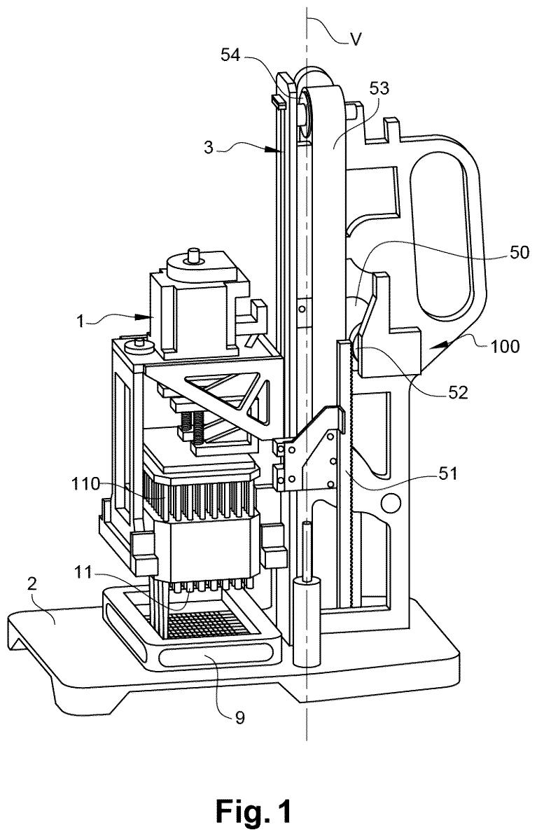

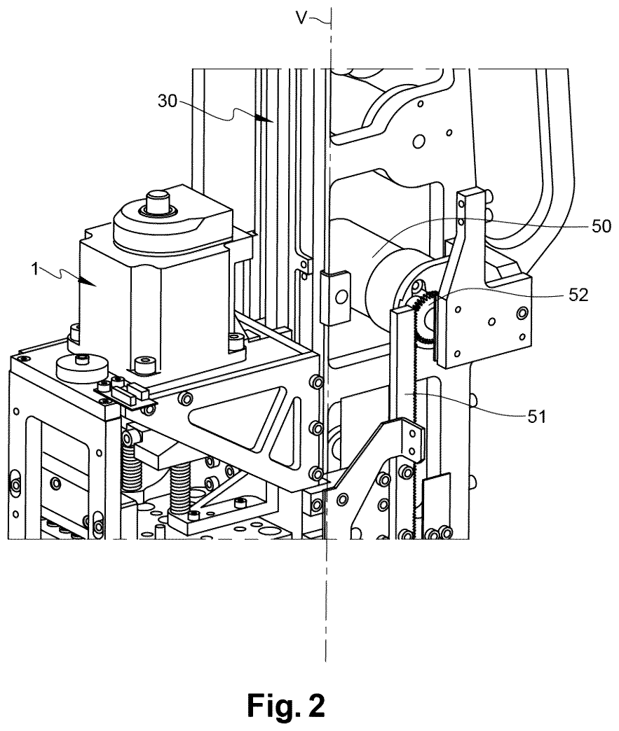

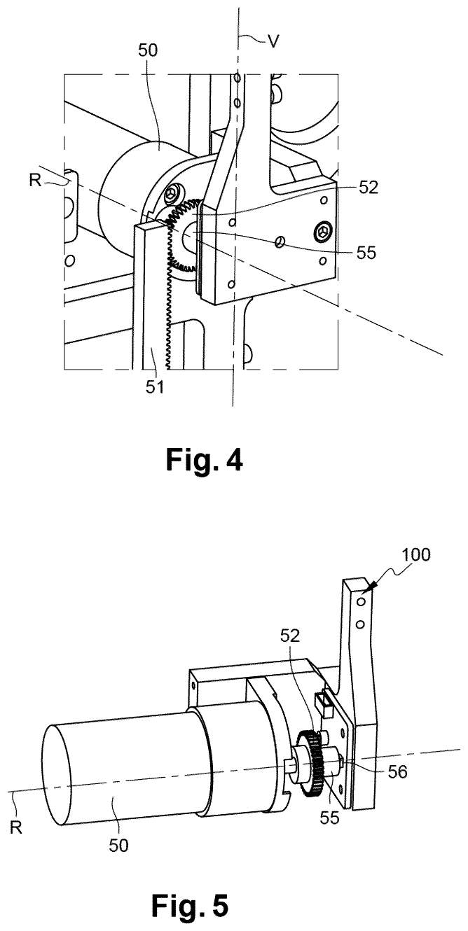

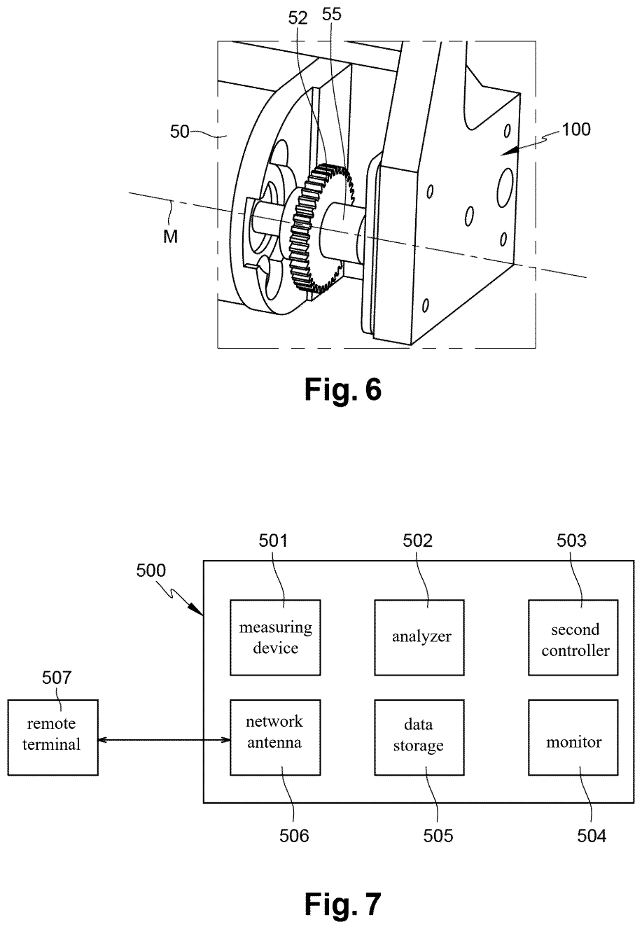

A first embodiment of the invention is now presented, in relation to FIGS. 1 to 12.

As illustrated, the pipetting system, which is here a semi-motorized pipetting system, comprises:
a frame 100 comprising a base 2 provided with at least one tray 9 configured to accommodate at least one consumable, and a tower 3 extending from the base 2 and comprising a linear guide rail 30 extending along a vertical axis V;
a pipetting head 1, and
means for driving the pipetting head 1 in translation.

In particular, the means for moving the pipetting head in translation allow the pipetting head 1 to be moved with the help of a user, i.e. accompanied by a movement initiated by a user.

These driving means comprise:
a motor 50 for driving in translation the pipetting head 1, comprising a motor shaft mounted so as to rotate about a motor axis R that is fixed relative to the frame 100 and substantially orthogonal to the vertical axis V;
a toothed pinion 52 mounted rotatably along the motor axis R;
a motion transmission roller 55 arranged between the motor 50 and the toothed pinion 52 to transmit a rotational movement between the motor 50 and the toothed pinion 52;
a rack 51 mounted to be movable in translation along the vertical axis V, the rack 51 being connected to the pipetting head 1 so as to drive it in translation, and being arranged in contact with the toothed pinion 52 so that a rotation of the toothed pinion 52 causes a translation of the rack 51 along the vertical axis V and a translation of the rack 51 along the vertical axis V causes a rotation of the toothed pinion 52.

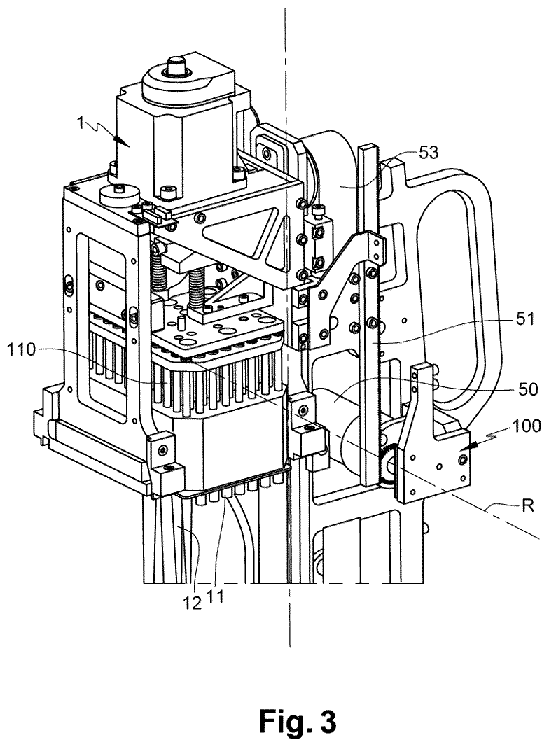

In this embodiment, and as shown in particular in FIGS. 1 and 3, the pipetting head 1 comprises a plurality of pipetting channels arranged in a rectangular matrix of rows and columns.

Each of the pipetting channels is intended to be provided with an end piece 11 configured to cooperate with a pipetting tip 12, so as to subsequently receive or dispense liquid into containers provided for this purpose.

However, according to another embodiment, the pipetting head could be provided only with a pipetting channel intended to be provided with an end piece.

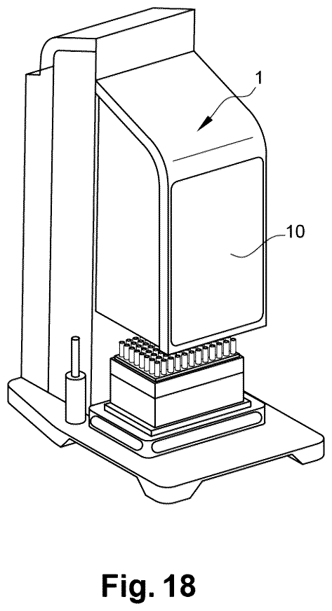

As can also be seen in FIG. 18, the pipetting head also comprises a casing 10 so as to protect the various components of this pipetting head from the external environment and therefore from premature wear or breakage.

The pipetting system also comprises a pipetting motor 100 arranged at the pipetting head so as to receive or dispense liquid into the liquid sampling or receiving containers disposed on the tray 9. More particularly, for receiving or dispensing liquid into the liquid sampling or receiving containers disposed on the tray 9, the motor drives pistons 110 which slide in the pipetting channels provided with end pieces.

According to the invention, this pipetting head 1 can be moved in translation along the linear guide rail 30 in at least one predefined range of movement, here a predefined range of movement, between at least one maximum position forming a maximum distance from the base 2 and a minimum position forming a minimum distance from the base 2.

It should be noted that this maximum position and this minimum position can be structurally defined, in particular by the size of the rack 51.

This minimum and maximum position, and therefore this minimum and maximum distance between the pipetting head and the base, can also be defined by a user making an adjustment, without this being structural.

The pipetting head 1 can also assume a storage position that may be within the position range between the minimum position and the maximum position, or be located outside the position range between the minimum and maximum positions.

To accompany the movement of the pipetting head, and more specifically hold the pipetting head 1 in a given position, for example as desired by a user, the means for driving the pipetting head 1 comprise at least one constant force spring 53 that can act along an axis 54, here a single constant force spring, connected to the rack 51 and configured to hold the pipetting head 1 in a given position.

In order to facilitate the positioning of the pipetting head 1, and in particular to assist with the movement of this pipetting head 1 while providing a pipetting system that allows the user a high degree of control, the pipetting system 1 further comprises control means 500 for activating and thus powering the motor simply when necessary.

According to the invention, the control means 500 comprise:
means for measuring 501 information representative of the distance between the pipetting head 1 and the base 2;
means for analyzing 502 the information representative of the distance between the pipetting head 1 and the base 2, so as to deduce the position of the pipetting head 1;
control means 503 configured to activate the motor 50 according to the position of the pipetting head 1 and at least one predefined stop, the at least one predefined stop being located between the maximum position and the minimum position of the pipetting head 1.

In this embodiment, the measuring means 501 comprise a magnetic encoder provided with a magnet 57 and a magnetometer 56.

The magnet 57 is fixed to the toothed pinion 52 and is provided opposite the magnetometer 56 fixed to the frame 100 of the pipetting system 1.

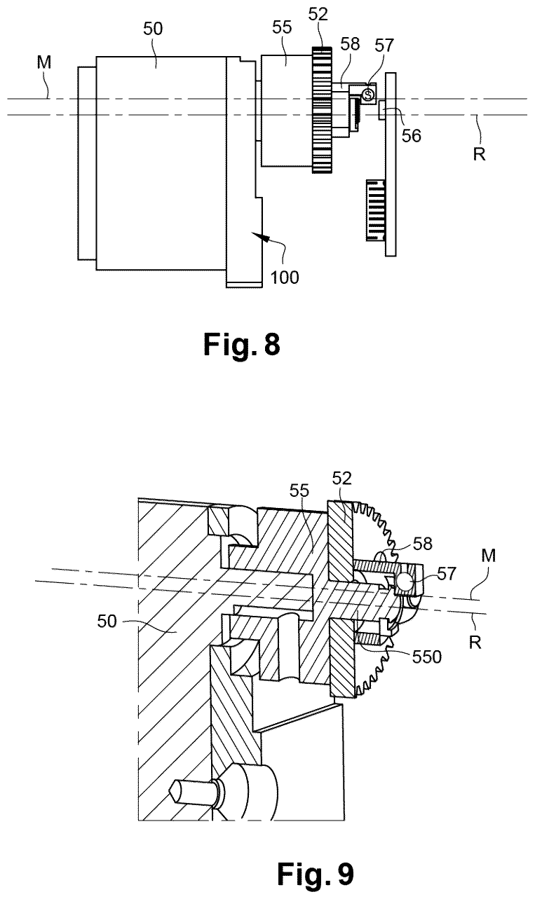

In the first embodiment presented, and as illustrated in particular in FIGS. 8 to 12, the magnet 57 is arranged on a support 58 fixed to the toothed pinion 52 and mounted so as to rotate about an axis M that is fixed relative to the frame 100 and which is parallel and offset relative to the motor axis R.

According to one variant, the magnet could be arranged on a support connected to the toothed pinion and mounted so that it can rotate about a fixed axis relative to the toothed pinion and parallel to the motor axis, without the latter being offset.

The support 58 is held in place by a pin 528 projecting from a surface of the toothed pinion 52 and housed in a hole formed in the support 58.

Furthermore, in order to lock the toothed pinion and support 58 in translation along the motor axis R, the pipetting system comprises means for locking in translation, here in the form of a circlip 8.

The magnetometer 56 is configured to measure a value of a magnetic field of the magnet 57, such that information representative of a distance from the pipetting head 1 comprises the value of the magnetic field of the magnet 57.

In this way, the rotation of the toothed pinion 52 about the motor axis R causes a variation in the value of the magnetic field of the magnet 57 measured by the magnetometer 56. Indeed, because the magnet 57 is fixed to the toothed pinion, which is driven in rotation at the same time as a movement of the pipetting head, while the magnetometer 56 is fixed to the frame, the magnet 57 is movable with respect to the magnetometer 56 and the value of the magnetic field of the magnet 57 measured by the magnetometer 56 therefore varies.

From this variation in the value of the magnetic field, and therefore the value of the magnetic field of the magnet measured by the measuring means 501, as well as the number of revolutions made by the toothed pinion 25, the analysis means 502 can deduce the position of the pipetting head 1.

More particularly, here, the analysis means can deduce a delay or an advance in the rotation of the motor relative to the rotation of the toothed pinion on the rack, as well as a number of revolutions made by the toothed pinion 25, and thus indirectly deduce the position of the pipetting head from this. These analysis means 502 may in particular comprise means for acquiring information representative of the distance between the pipetting head 1 and the base 2 measured by the measuring means 501, as well as processing means for converting this value of the magnetic field of the magnet measured by the measuring means 501 and this number of revolutions made by the toothed pinion into a position of the pipetting head 1.

With regard to the control means 503, depending on the position of the pipetting head 1 and at least one predefined stop, they activate the motor 50 so as to accompany the translational movement of the pipetting head 1 and/or block the translation.

In particular, when the pipetting head reaches the level of the at least one predefined stop, the control means activate said motor so as to block the translational movement of the pipetting head along said linear guide rail.

It should be noted that this predefined stop can in particular be defined by a user making an adjustment.

To define this predefined stop, the control means 500 may in particular comprise, as illustrated in FIG. 7, storage means 505 for storing data or information, and network antenna 506 capable of communicating data or information with a remote terminal 507, the remote terminal 507 allowing the user to enter a value representative of a predefined stop which would then be stored in the storage means 505.

The user could also enter several predefined stops.

In the first embodiment presented, and as illustrated more particularly in FIGS. 9 to 12, the motion transmission roller 55 has a protrusion 550 extending along the motor axis R and around which the toothed pinion 52 is rotatably mounted. In addition, the toothed pinion 52 comprises two through elongated holes 520a, 520b that are symmetrical with respect to the motor axis R, the motion transmission roller 55 having two protruding pins extending opposite the toothed pinion 52. In this way, each of the two pins 551a, 551b is mounted so as to slide in one of the two elongated holes 520a, 520b by movement of the motion transmission roller 55 relative to the toothed pinion 52.

In other words, the toothed pinion 52 is mounted so that it can move relative to the motion transmission roller 55 in a range of movement limited by the elongated holes, since the freedom of movement is only allowed when the two pins slide in the two elongated holes.

Since the elongated holes are symmetrical, and the two pins 551a, 551b and the motor axis R are aligned in a plane orthogonal to the vertical axis V, one of the two pins reaches an upper end of the elongated hole in which it moves when the other of the two pins reaches a lower end of the elongated hole in which it moves.

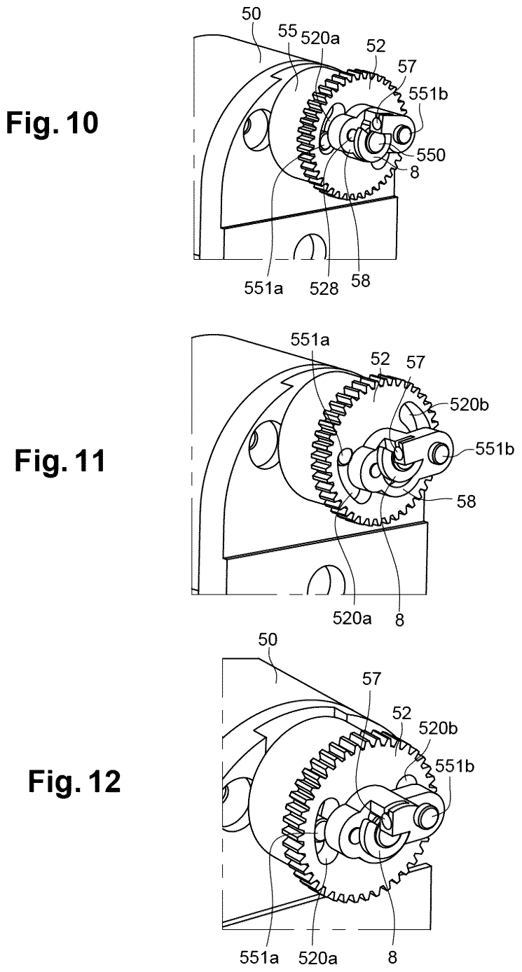

More specifically, FIG. 10 shows a view in which the pin 520a has reached a lower end of the elongated hole 551a, while the pin 520b has reached an upper end of the elongated hole 551b.

In contrast, FIG. 11 shows a view in which the pin 520b has reached a lower end of the elongated hole 551b while the pin 520a has reached an upper end of the elongated hole 551a.

In this embodiment, one of the two pins 551b forms the axis of rotation M of the support 58. Thus, the value of the magnetic field of the magnet 57 measured by the magnetometer 56 depends on a position of each of the two pins 551a, 551b in the two elongated holes 520a, 520b

Thus, this sliding of the pins in the elongated holes makes it possible to detect movement of the pipetting head 1, which will cause the toothed pinion 52 to rotate and therefore the pins to slide in the elongated holes.

So that the motor 50 can be activated as soon as the pipetting head 1 is set in motion, in particular to accompany the movement of the pipetting head in order to compensate for the defects felt when the motor is not powered, such as the passage of the rack teeth and the motor teeth, the measuring means 501 are therefore configured to detect a movement of the pipetting head 1 by sliding each of the two pins 551a, 551b in the two elongated holes 520a, 520b from a default position in which each of the two pins 551a, 551b is centered relative to the elongated hole 520a, 520b in which it is slidably mounted, and an offset position in which each of the two pins 551a, 551b is offset relative to the center of the elongated hole 520a, 520b in which it is slidably mounted.

For optimal operation of the pipetting system according to this embodiment, and so that the action of the motor is sufficient without being excessive, the control means 503 are configured to control the rotational speed of the motor 50 so as to return each of the two pins 551a, 551b to the default position.

Indeed, a sufficient and proportionate motor rotational speed not only makes it possible to limit consumption as well as the noise associated with the motor but also makes it possible to mitigate undesirable effects caused by the vertical translational movement of the pipetting head, such as the passage of each of the teeth of the rack 51.

Moreover, in this embodiment, when the pipetting head reaches the level of at least one predefined stop, each of the two pins 551a, 551b abuts against an edge of the elongated hole 520a, 520b in which it is slidably mounted. This allows the pipetting head to be locked in position at this stop.

The fact that each of the two pins 551a, 551b abuts against an edge of the elongated hole 520a, 520b in which it is slidably mounted is due to the change in rotational speed of the motor.

In the first embodiment, the control means 500 illustrated in FIG. 7 further comprise monitoring means 504 capable of delivering information belonging to the group comprising:
information on the presence of a support on said tray;

### Number of Pipetting Tips Not yet Used

information relating to a protocol step to be performed, in progress, or completed;
information on the date or time when a pipetting protocol was performed;
a scheduled maintenance date;
information identifying consumables present on the tray;
identification information on the pipetting system;
information on the arrival of the pipetting head in the stop position;
information on the vertical position of the pipetting head and/or the distance between the pipetting head and the base.

The system may also be provided with monitoring means, arranged on the pipetting head 1 and intended to be positioned opposite the tray 9.

It should be noted that, in an alternative, these monitoring means could also be arranged on the tower.

These monitoring means could also be arranged on or under the tray.

Such monitoring means may for example comprise a CCD or CMOS camera for checking the number of tip lines fitted, checking whether the consumable (which may be the pipetting tip holder or the pipetting tips) is present or missing from the tray, checking the position of the tray, checking the actions performed (taking up pipetting tips, presence of liquid in consumables), or even checking the type of tray installed in the case of a pipetting system with multiple rotating trays.

The monitoring means may also consist of LEDs, for example.

They may also consist of one or more accelerometers for monitoring the positioning or movement of one or more trays relative to the pipetting head.

The system may also be provided with means for recognizing pipetting tip holders. Such recognition means may in particular comprise a color sensor arranged on the tower 3, facing the tray 9.

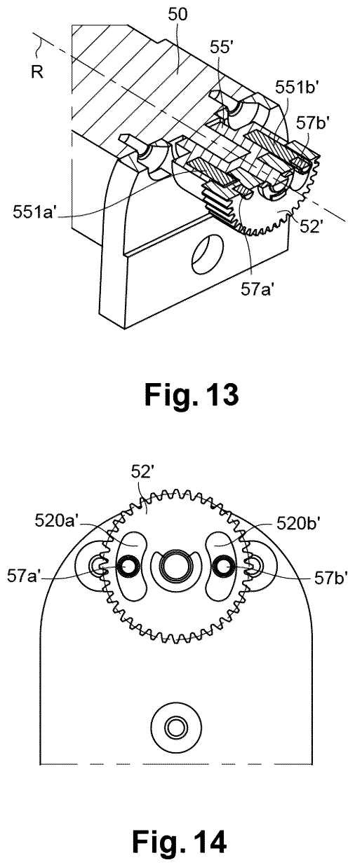

A second embodiment of the invention will now be presented, with reference to FIGS. 13 and 14.

In this embodiment, the features common with the first embodiment are not detailed again.

As shown in FIGS. 13 and 14 of this embodiment, the toothed pinion 52′ comprises a through elongated hole 520b′ and a blind elongated hole 520a′, that are symmetrical in extent with respect to the motor axis R. For its part, the motion transmission roller 55′ has two pins 551a′ and 551b′, extending in projection opposite the toothed pinion 52′ so that each of the two pins 551a′, 551b′ is mounted slidably in one of the two elongated holes 520a′, 520b′ by movement of the motion transmission roller 55′ relative to the toothed pinion 52′, one of the two pins 551a′ being shorter than the other of the two pins 551b′ so as to be able to slide in the blind elongated hole 520a′. The two pins and the motor axis R are also aligned here in a plane orthogonal to the vertical axis V.

Here, the measuring means comprise a magnetic encoder fitted with two magnets 57a′, 57b′ and a magnetometer (not shown). One magnet 57b′ of these two magnets is arranged on the one of the two pins that is mounted so as to slide in the through elongated hole 520b′, while the other of the two magnets is housed in the toothed pinion 52′ so as to face a center of the elongated hole 520a′ and thus configured to face the one of the two pins that is mounted slidably in the blind elongated hole 520a′ in the default position.

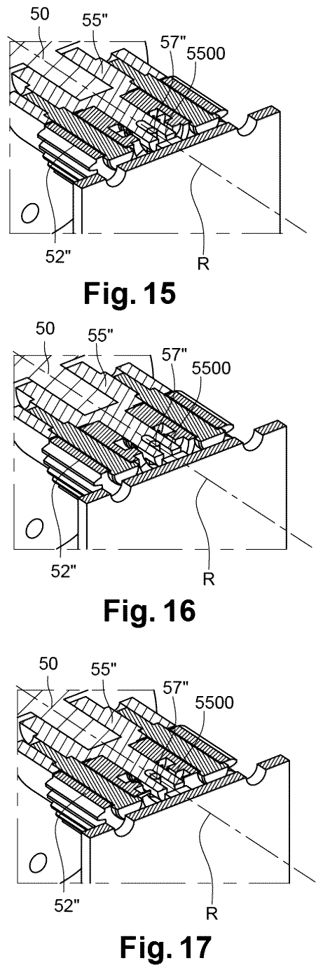

A third embodiment of the invention is now presented, with reference to FIGS. 15 and 17.

The features common to the first and second embodiments are not detailed again.

In this embodiment, the measuring means comprise a magnetic encoder provided with a magnet 57″ and a magnetometer (not shown). This magnet is arranged so as to be coaxial with the toothed pinion 52″ and the motion transmission roller 55″.

More specifically, in this embodiment, the motion transmission roller 55″ has a protrusion extending along the motor axis R, around which said toothed pinion 52″ is rotatably mounted.

The toothed pinion 52″ comprises two elongated holes symmetrical to the motor axis R, and the motion transmission roller has two pins extending protruding opposite the toothed pinion so that each of the two pins is mounted to slide in one of the two elongated holes by movement of the motion transmission roller relative to the toothed pinion, the two pins and the motor axis being aligned in a plane orthogonal to the vertical axis V.

In this embodiment, the magnet 57″ is arranged in a housing 5500 formed in the protrusion and is mounted so that it can rotate helically about the motor axis R.

Thus, the number of revolutions made by the toothed pinion 52″ depends on the distance between the magnet 57″ and the magnetometer.

Thus, and unlike the measuring means of the first embodiment, the magnet 57″ is mounted so that it can rotate helically along the motor axis R and therefore rotates on itself on the axis R and moves axially on this same motor axis R according to the relative angular displacement of the toothed pinion relative to the motion transmission roller. Thus, the magnetometer of this embodiment is a three-axis magnetometer, capable of detecting a variation not only in a plane perpendicular to the motor axis R but also a variation on this motor axis R. Conversely, the magnetometer of the first embodiment is a two-axis magnetometer, which is only capable of detecting a variation in a plane perpendicular to the motor axis R.

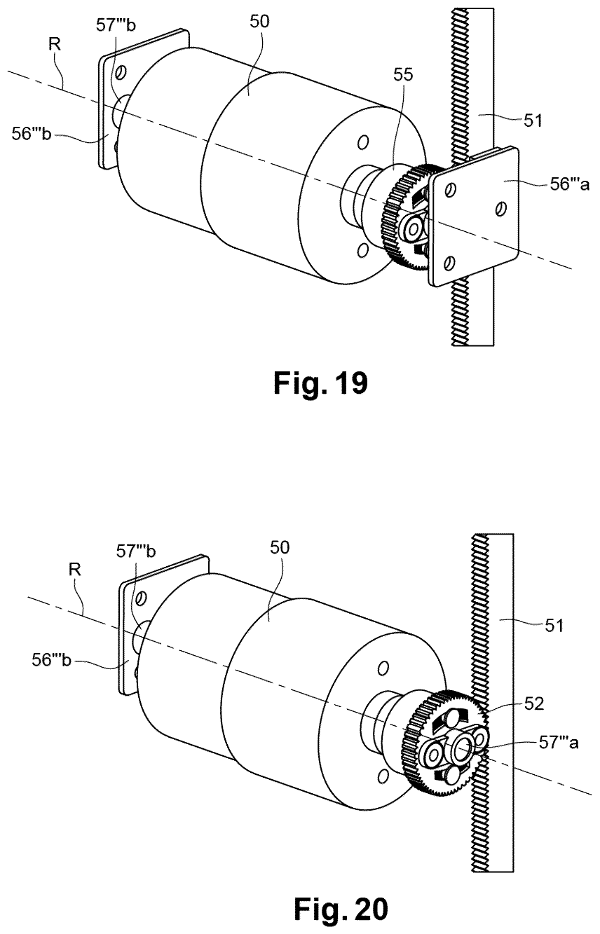

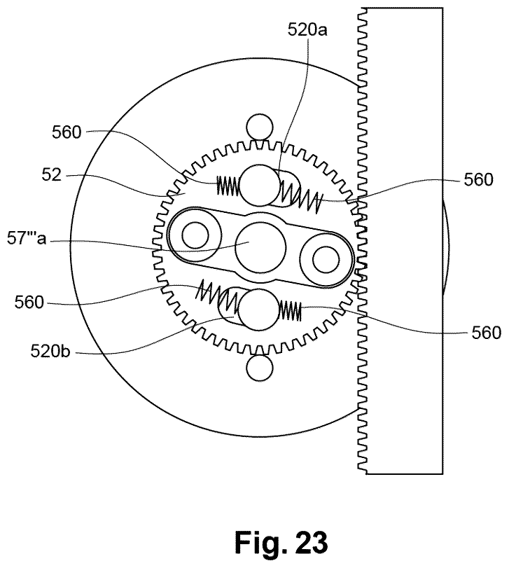

A fourth embodiment of the invention is now presented, with reference to FIGS. 19 to 23.

The features common with the other embodiments are not detailed again. In this embodiment, the measuring means 501 comprise an angle encoder provided with two magnets 57′″a, 57′″b and two angle sensors 56′″a, 56′″b.

More specifically, a first of the two magnets 57′″a is fixed to the toothed pinion 52 and is provided facing a first of the two angle sensors 56′″a fixed to the frame 100 of the pipetting system such that it is configured to measure an angle variation at the toothed pinion 52.

Furthermore, a second of the two magnets 57′″b is fixed to the motor 50 and is arranged facing a second of the two angle sensors 56′″b fixed to the frame 100 of the pipetting system such that it is configured to measure an angle variation at the motor 50.

Thus, in this embodiment, a rotation of the toothed pinion 52 about the motor axis R results in a variation of the angle value of the first of the two magnets 57′″a measured by the first of the two angle sensors 56′″a, and therefore results in a phase shift between the angle value of the first of the two magnets 57′″a measured by the first of the two angle sensors 56′″a and the angle value of the second of the two magnets 57′″b measured by the second of the two angle sensors 56′″b.

Therefore, in this embodiment, the information representing the distance of the pipetting head 1 is measured by the angle encoder, and comprises a number of revolutions made by the toothed pinion 52 and the phase shift value between the angle value of the first of the two magnets 57′″a measured by the first of the two angle sensors 56′″a and the angle value of the second of the two magnets 57′″b measured by the second of the two angle sensors 56′″b. The analysis means 502 deduce the position of the pipetting head 1 from this phase shift value and the number of revolutions performed by the toothed pinion 52.

It should be noted that the number of revolutions made by the toothed pinion can, for example, be deduced from the rotation of the second of the two magnets.

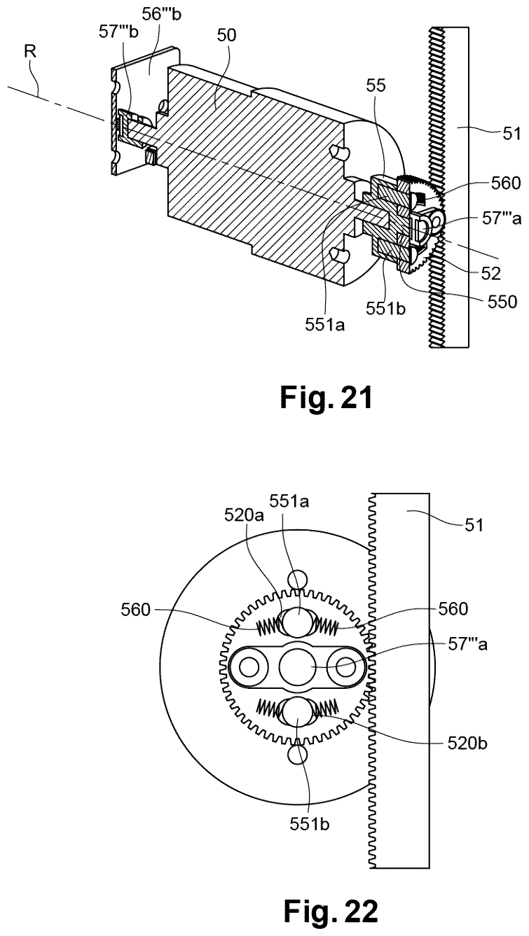

Furthermore, in this embodiment, and as can be seen in particular in FIG. 21, the motion transmission roller 55 has a protrusion 550 extending along the motor axis R and around which the toothed pinion 52 is mounted so as to rotate. This toothed pinion 52 comprises two elongated holes 520a, 520b symmetrical to the motor axis R, while the motion transmission roller 55 has two protruding pins facing the toothed pinion 52 so that each of the two pins 551a, 551b is mounted so as to slide in one of the two elongated holes 520a, 520b by movement of the motion transmission roller 55 relative to the toothed pinion 52.

Thus, when the pipetting head reaches the level of the at least one predefined stop, each of the two pins 551a, 551b abuts against an edge of the elongated hole 520a, 520b in which it is slidably mounted.

In this embodiment, each of the two pins 551a, 551b is connected on either side of one of the two elongated holes 520a, 520b by means of two return springs 560 positioned so as to return each of these two pins 551a, 551b to said default position.

According to one alternative, the number of springs could be different. For example, it is possible to use four springs so as to accelerate the return to the initial position.

The invention also relates to a method for controlling a pipetting system according to one of the three embodiments presented, implemented by the control means 500.

The method comprises the following steps:
a step of measuring, using the measuring means 501, information representative of the distance between the pipetting head 1 and the base 2;
a step of analyzing, using analysis means 502, information representative of the distance between the pipetting head 1 with the base 2, so as to deduce the position of the pipetting head 1 therefrom;
a step of controlling the motor 50, by the control means 503, according to the position of the pipetting head 1 and at least one predefined stop, this at least one predefined stop being located between the maximum position and the minimum position of the pipetting head 1.

In this embodiment, and as described above, the control method also comprises a preliminary step of setting the parameters of at least one predefined stop.

This step may be performed by a user, who may be an operator or a laboratory technician, using the control means, and in particular using a remote terminal 507 connected to network antenna 506 so as to send and receive information to and from the control means 500.

It should be noted that this configuration step can be repeated several times, for example a number of times corresponding to the number of stops to be programmed.

Thus, the method may comprise a step of detecting arrival at the at least one predefined stop, the control means then activating said motor so as to block the translational movement of the pipetting head along said linear guide rail.

It should be noted that the motor can be controlled by time or force, so that this stop is only temporary, for example the time for moving a consumable or for moving to a next step of a pipetting protocol.

This step of detecting arrival at the at least one predefined stop may further comprise a step of transmitting information to a user about the arrival at the stop, for example by visual, audible, or haptic means.

In this embodiment, the analysis step is at least partially performed by means of a calculation algorithm based on the angular offset measured by the magnetometer.

In this embodiment, the control method comprises a step of detecting the movement of the pipetting head 1 by detecting, by the measuring means 501, a sliding of each of the two pins 551a, 551b in the two elongated holes 520a, 520b from a default position, in which each of the two pins 551a, 551b is centered relative to the elongated hole 520a, 520b in which it is slidably mounted, and an offset position, in which each of the two pins 551a, 551b is offset relative to the center of the elongated hole 520a, 520b in which it is slidably mounted.

As a result and following the step of detecting the movement of the pipetting head 1, the control method comprises a step of controlling the rotational speed of the motor 50, by the control means 503, so as to return each of the two pins 551a, 551b back to the default position. Before using it, such as in a pipetting protocol, or at the start of the day, the control method may also comprise a preliminary step of calibrating the measuring means 501 in order to calibrate them before proceeding with sampling or titration, for example.

In addition, prior to use, such as in a pipetting protocol, or at the start of the day, the control method may also comprise a step of positioning the pipetting head 1 from a storage position to the predefined range of motion.

On the contrary, at the end of the day or after use, the control method may also comprise a step of positioning the pipetting head from said predefined range of movement to a storage position.

1-24. (canceled)

25. A pipetting system comprising:
a frame comprising a base provided with at least one tray configured to accommodate at least one consumable, and a tower extending from the base and comprising at least one linear guide rail extending along a vertical axis;
a pipetting head housing at least one pipetting channel provided with an end piece configured to cooperate with a pipetting tip, to receive or dispense a liquid, the pipetting head configured to move translationally along the linear guide rail in at least one predefined range of movement between at least one maximum position of the pipetting head forming a maximum distance from the base and a minimum position of the pipetting head forming a minimum distance from the base;
a driver to drive the pipetting head translationally comprising:
a motor to drive the pipetting head translationally, the motor comprising a motor shaft mounted rotatably about a motor axis fixed relative to the frame and orthogonal to the vertical axis;
a toothed pinion mounted rotatably about the motor axis;
a motion transmission roller arranged between the motor and the toothed pinion to transmit a rotational movement between the motor and the toothed pinion; and
a rack mounted to be movable translationally along the vertical axis, the rack being integral with the pipetting head to drive the pipetting translationally and the rack being arranged in contact with the toothed pinion, so that a rotation of the toothed pinion results in a translation of the rack along said vertical axis and the translation of the rack along the vertical axis causes the toothed pinion to rotate; and
a first controller comprising:
a measuring device to measure information representative of a distance of the pipetting head from the base;
an analyzer to analyze the information representative of the distance of the pipetting head from the base, to determine therefrom a position of the pipetting head; and
a second controller configured to activate the motor according to the position of the pipetting head and at least one predefined stop, said at least one predefined stop being located between said at least one maximum position of the pipetting head and the minimum position of the pipetting head.

26. The pipetting system of claim 25, when the pipetting head reaches said at least one predefined stop, the second controller activates the motor to block a translational movement of the pipetting head along the linear guide rail.

27. The pipetting system of claim 25, wherein the measuring device comprises a magnetic encoder comprising at least one magnet and a magnetometer fixed to the frame, said at least one magnet being fixed to the toothed pinion and facing the magnetometer and the magnetometer configured to measure a value of a magnetic field of said at least one magnet such that the rotation of the toothed pinion about the motor axis causes a variation in the value of the magnetic field of said at least one magnet measured by the magnetometer; and
wherein the magnetic encoder measures the information representative of the distance of the pipetting head from the base, the information representative of the distance comprises a number of revolutions performed by the toothed pinion and the value of the magnetic field of said at least one magnet, and the analyzer deducts the position of the pipetting head from the value of the magnetic field of said at least one magnet and from the number of revolutions performed by the toothed pinion.

28. The pipetting system of claim 27, wherein the motion transmission roller comprises a protrusion extending along the motor axis and around which the toothed pinion is rotatably mounted; wherein the toothed pinion comprises two elongated holes that are symmetrical with respect to the motor axis; and wherein the motion transmission roller further comprises two pins extending opposite the toothed pinion so that each of said two pins is mounted slidably in one of said two elongated holes by movement of the motion transmission roller relative to the toothed pinion, the two pins and the motor axis being aligned in a plane orthogonal to the vertical axis.

29. The pipetting system of claim 28, wherein said at least one magnet is housed in a recess formed in the protrusion and is mounted to be movable in a helical rotation about the motor axis; and wherein the number of revolutions performed by the toothed pinion depends on a distance of said at least one magnet from the magnetometer.

30. The pipetting system of claim 28, wherein said at least one magnet is arranged on a support connected to the toothed pinion and mounted to be rotatable about an axis of rotation that is fixed relative to the toothed pinion and parallel to the motor axis.

31. The pipetting system of claim 30, wherein one of the two pins forms the axis of rotation, the axis of rotation being parallel and offset with respect to the motor axis; and
wherein the value of the magnetic field of said at least one magnet measured by the magnetometer depends on a position of each of the two pins in the two elongated holes.

32. The pipetting system of claim 28, wherein the measuring device is configured to detect a movement of the pipetting head by sliding said each of said two pins in the two elongated holes from a default position in which each pin is centered relative to an elongated hole in which said each pin is slidably mounted therein, and an offset position in which said each pin is offset with respect to a center of the elongated hole in which said each pin is slidably mounted therein; and wherein the second controller is configured to control a speed and a direction of rotation of the motor to return the two pins to the default position.

33. The pipetting system of claim 28, wherein each pin abuts against an edge of an elongated hole in which said each pin is slidably mounted therein when the pipetting head reaches said at least one predefined stop.

34. The pipetting system of claim 25, wherein the measuring device comprises an angle encoder comprising two magnets and two angle sensors, a first magnet is fixed to the toothed pinion and is arranged facing a first angle sensor fixed to the frame, the first angle sensor is configured to measure an angle value at the toothed pinion, and a second magnet is attached to the motor and is arranged facing a second angle sensor attached to the frame, the second angle sensor is configured to measure an angle value at the motor; and wherein a rotation of the toothed pinion about the motor axis causes a variation of the angle value measured by the first angle sensor and causes a phase shift between the angle value measured by the first angle sensor and the angle value measured by the second angle sensor; and
wherein the angle encoder measures the information representative of the distance of the pipetting head from the base, the information representative of the distance comprises a number of revolutions performed by the toothed pinion and a value of the phase shift, and the analyzer deducts the position of the pipetting head from the value of the phase shift and the number of revolutions performed by the toothed pinion.

35. The pipetting system of claim 34, wherein the motion transmission roller comprises a protrusion extending along the motor axis and around which the toothed pinion is rotatably mounted; wherein the toothed pinion comprises two elongated holes that are symmetrical with respect to the motor axis; and wherein the motion transmission roller further comprises two pins extending opposite the toothed pinion so that each of said two pins is mounted slidably in one of said two elongated holes by movement of the motion transmission roller relative to the toothed pinion, the two pins and the motor axis being aligned in a plane orthogonal to the vertical axis.

36. The pipetting system of claim 35, wherein each pin abuts against an edge of an elongated hole in which said each pin is slidably mounted therein when the pipetting head reaches said at least one predefined stop.

37. The pipetting system of claim 36, wherein said each pin is connected on either side of a corresponding elongated hole by a return spring to return said each pin to a default position in which said each pin is centered relative to the corresponding elongated hole.

38. The pipetting system of claim 25, wherein the driver further comprises at least one constant force spring connected to the rack and said at least one constant force spring is configured to hold the pipetting head in a given position.

39. The pipetting system of claim 25, further comprising a monitor arranged on the pipetting head or on the tower, the monitor being positioned opposite said at least one tray and the monitor is configured to deliver information comprising at least one of the following:
information on a presence of a support on said at least one tray;
a number of pipetting tips not yet used;
information relating to a protocol step to be performed, in progress, or completed;
information on a date or time when a pipetting protocol was performed;
a scheduled maintenance date;
information identifying consumables present on said at least one tray;
identification information on the pipetting system;
information on an arrival of the pipetting head in a stop position;
information on a vertical position of the pipetting head; and
information on the distance of the pipetting head from the base.

40. The pipetting system of claim 25, wherein the first controller further comprises at least one of a data storage and a network antenna configured to communicate with a remote terminal.

41. A method for controlling the pipetting system of claim 25 implemented by the first controller, the method comprising:
measuring the information representative of the distance of the pipetting head from the base by the measuring device;
analyzing the information representative of the distance of the pipetting head from the base by the analyzer, to determine therefrom the position of the pipetting head; and
controlling the motor according to the position of the pipetting head and at least one predefined stop by the second controller.

42. The method of claim 41, further comprising at least one of:
configuring said at least one predefined stop;
calibrating the measuring device;
positioning the pipetting head from a storage position to said at least one predefined range of motion or from said at least one predefined range of motion to the storage position; and
detecting an arrival at said at least one predefined stop, the second controller activating the motor to block a translational movement of the pipetting head along the linear guide rail.

43. The method of claim 41, wherein the toothed pinion comprises two elongated holes that are symmetrical with respect to the motor axis; wherein the motion transmission roller further comprises two pins extending opposite the toothed pinion so that each of said two pins is mounted slidably in one of said two elongated holes by movement of the motion transmission roller relative to the toothed pinion; and the method further comprising detecting movement of the pipetting head by detecting sliding of each pin in a corresponding elongated hole from a default position in which said each pin is centered relative to the corresponding elongated hole to an offset position in which said each pin is offset relative to a center of the corresponding elongated hole.

44. The method of claim 43, further comprising controlling a rotational speed of the motor, by the second controller, to return said each pin to the default position.
